(19) United States
(12) Patent Application Publication
(10) Pub. No.: US 2010/0051751 A1
(43) Pub. Date: Mar. 4, 2010

(54) REUSABLE ORBITAL VEHICLE WITH INTERCHANGEABLE MODULES

(76) Inventors: George E. Mueller, Kirkland, WA (US); Richard H. Kohrs, Kirkland, WA (US); Dean L. Misterek, Seattle, WA (US); David B. Cochran, Duvall, WA (US); William B. Duncan, Kirkland, WA (US); Charles D. Limerick, Issaquah, WA (US)

Correspondence Address: DAVIS WRIGHT TREMAINE, LLP/Seattle, 1201 Third Avenue, Suite 2200, SEATTLE, WA, 98101-3045, US

(21) Appl. No.: 12/615,892

(22) Filed: Nov. 10, 2009

Related U.S. Application Data
(63) Continuation of application No. 11/172,033, filed on Jun. 29, 2005.

(51) Int. Cl. B64G 1/60; B64G 1/24; B64G 1/64; B64G 1/46; B64G 1/52; B64G 1/66

(52) U.S. Cl. 244/158.9

(57) ABSTRACT

A reusable module is affixed atop a reusable orbital vehicle (OV). Various configurations of the reusable module have identical external dimensions in the region of attachment to the OV, aerodynamic characteristics, and mounting configurations to permit interchangeability. Different configurations can accommodate a variety of missions of different type and duration. The module may be a cargo module, a satellite payload module or a passenger module. The passenger module is provided in a variety of configurations to accommodate a different number of passengers and cargo based on mission parameters.

### CROSS REFERENCE TO RELATED APPLICATION

This application is a continuation of U.S. patent application Ser. No. 11/172,033 filed Jun. 29, 2005, which is incorporated by reference herein in its entirety.

### BACKGROUND OF THE INVENTION

1. Field of the Invention

The present invention is directed generally to rockets, and, more particularly, to a reusable orbital vehicle with a reusable interchangeable module.

2. Description of the Related Art

The modern space age may be thought of as beginning on Oct. 4, 1957 with the launch of Sputnik I. From that time until the launch of the first space shuttle in 1981, all portions of the space vehicle were expendable. That is, no parts were reused in subsequent missions.

With the advent of the space shuttle, the solid rocket boosters and orbital vehicle itself were recycled for use in subsequent missions. The large external fuel tank burns up on re-entry and is not recycled. Even with the reusable portions of the space shuttle, the launch cost and operational cost of the space shuttle is significant.

Virtually all satellites, such as communications satellites, weather satellites, and the like, are currently launched on expensive, expendable launch vehicles that are discarded after placing their payloads into orbit. Similarly, orbital vehicles that currently supply the international space station (ISS) are typically expendable vehicles. That is, the booster rocket that places the orbital vehicle into low Earth orbit burns up upon re-entry. After providing supplies to the ISS, the orbital vehicle is not reusable.

At present, the space shuttle is the only reusable vehicle for placing passengers in orbit. Despite the recycling of some components, those skilled in the art will appreciate that the operation of the space shuttle presents a significant cost burden. Therefore, it can be appreciated that there is a significant need for a system and method for a reusable space vehicle that allows passengers to be placed in orbit. The present invention provides this and other advantages as will be apparent from the following detailed description and accompanying figures.

### BRIEF DESCRIPTION OF THE SEVERAL VIEWS OF THE DRAWING(S)

FIG. 1 is a partial cutaway elevation view of the space launch vehicle.

FIG. 2 is a perspective view of the orbital vehicle in a closed configuration.

FIG. 3 is a perspective view of the orbital vehicle in an open configuration.

FIG. 4 is a perspective view of one embodiment of a passenger module portion of the orbital vehicle with nosecap removed for clarity.

FIG. 5 is a perspective view of the passenger module portion of FIG. 4 with nosecap removed for clarity.

FIG. 6 is a perspective view of the passenger module of FIG. 4 with a structure and nosecap removed to illustrate passenger seating.

FIG. 7 is a cross-section elevation view of the interior portion of the passenger module.

FIG. 8 is a side cross-section view of the passenger module of FIG. 7.

FIG. 9 is a perspective view of the rear portion of the passenger module.

FIG. 10 is a perspective view of the rear portion of the passenger module.

FIG. 11 is a perspective view of an alternative embodiment of the passenger module in an open configuration.

FIG. 12 is a partial cutaway view of the passenger module of FIG. 11.

FIG. 13 is a view of the interior portion of the passenger module of FIG. 11.

FIG. 14 is a cutaway perspective view of another alternative embodiment of a passenger module.

FIG. 15 is a perspective view of an orbital vehicle with the passenger module of FIG. 14.

FIG. 16 is a perspective view of an orbital vehicle with an alternative payload module.

FIG. 17 is a perspective view of an orbital vehicle with another alternative payload module.

FIG. 18 is a perspective view of an orbital vehicle with another alternative payload module.

FIGS. 19-20 are side cutaway views of the module mounted on the orbital vehicle of FIG. 18.

### DETAILED DESCRIPTION OF THE INVENTION

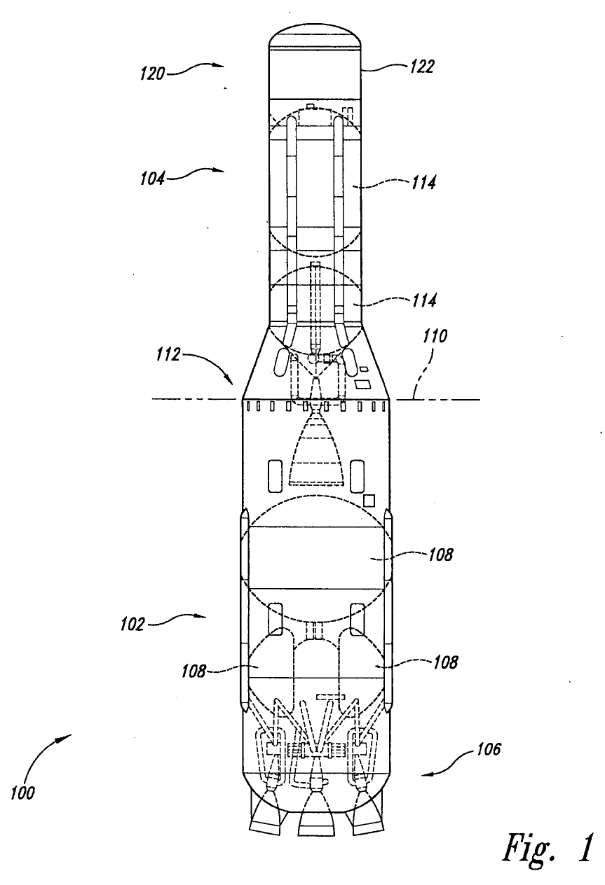

A reusable passenger module having standardized dimensions is designed to fit atop a reusable orbital vehicle to provide low cost delivery and retrieval of passengers into orbit. Although other suitable launch vehicles are possible, the reusable space launch vehicle 100, shown in FIG. 1, may be satisfactorily implemented by the Kistler K-1 vehicle. The space launch vehicle 100 comprises a launch assist platform (LAP) 102, which is sometimes referred to as a booster rocket. An orbital vehicle (OV) 104 is mounted atop the LAP 102. The Kistler K-1 vehicle utilizes three LAP engines 106. Fuel is supplied to the LAP engines 106 from LAP fuel tanks 108. In a typical implementation, separate fuel tanks contain rocket propellant and liquid oxygen (LOX). Operation of the LAP engines 106 and LAP fuel tanks 108 is known to one of skill in the art and need not be described in greater detail herein. The LAP 102 also contains avionics hardware, such as a vehicle computer, GPS, guidance system, transmitter(s), receiver(s), FAA transponder, and the like. Appropriate avionics software is used by portions of the avionics hardware, such as the vehicle computer. Operational details of these elements are known in the art, and need not be described in greater detail herein.

In an exemplary embodiment, the Kistler K-1 is designed for terrestrial launch and landing. The LAP 102 also includes parachutes and airbags to assist in recovery of the LAP. The launch and recovery of the LAP 102 is illustrated in U.S. Pat. No. 6,158,693, which is assigned to the assignee of the present disclosure. U.S. Pat. No. 6,158,693 is incorporated herein by reference in its entirety.

In an exemplary embodiment, the LAP 102 provides an initial boost to a predetermined altitude of approximately 135,000 feet. The space launch vehicle 100 initiates a separation of the LAP 102 and the OV 104. Following separation, the center engine of the LAP engines 106 fires to provide a controlled return trajectory to the initial launch site or designated alternative landing site. At an altitude of approximately 17,000 feet the LAP 102 deploys parachutes (not shown) and airbags (not shown) to provide a soft landing at the launch site. The LAP 102 is designed to return to the launch area approximately ten minutes after lift-off.

FIG. 1 illustrates a separation plane, shown by the reference numeral 110, that separates the OV 104 from the LAP 102. Known separation mechanisms, such as explosive bolts, may be utilized to separate the OV 104 from the LAP 102 at the predetermined altitude.

Following separation, an OV engine 112 ignites to place the OV 104 in Earth orbit. The OV engine 112 is supplied with fuel from OV fuel tanks 114. In a typical implementation, the OV fuel tanks 114 provide separate storage for kerosene fuel and LOX oxidizer. Operational details of the OV engine 112 and OV fuel tanks 114 are known to those skilled in the art and need not be described in greater detail herein.

The OV 104 also contains avionics hardware, such as a vehicle computer, guidance system, transmitter(s), receiver(s), and the like. Appropriate avionics software operates on the avionics hardware. Operational details of the avionics hardware and software in the OV 104 are known to those skilled in the art, and need not be described in greater detail herein. The OV 104 is designed for automatic guidance to a rendezvous point in orbit. The rendezvous point may be a predetermined orbit, such as a location to rendezvous with a satellite or scientific instrument (e.g., the Hubble telescope). In an embodiment described herein, the OV is designed to rendezvous with another orbiting body, such as, by way of example, the International Space Station (ISS).

A module 120 sits atop the OV 104. In an exemplary embodiment, the module 120 comprises one of several different interchangeable modules having selected common dimensions, attachment structural elements and aerodynamic characteristics. In an embodiment described herein, the module 120 is implemented as a passenger module 122.

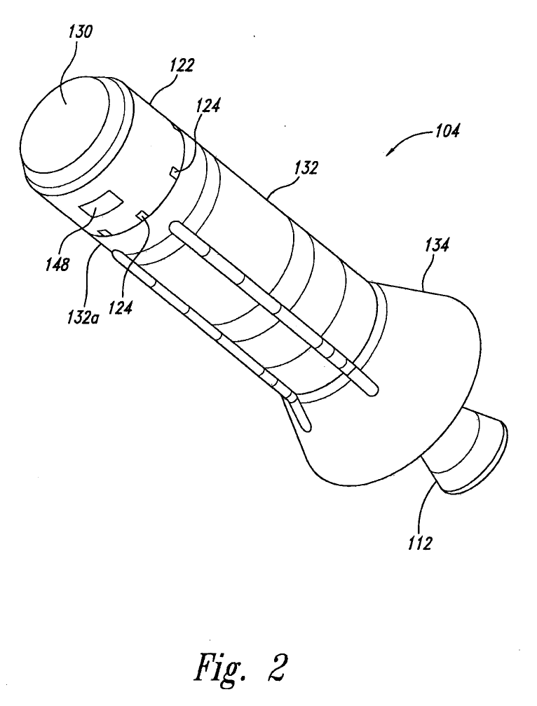

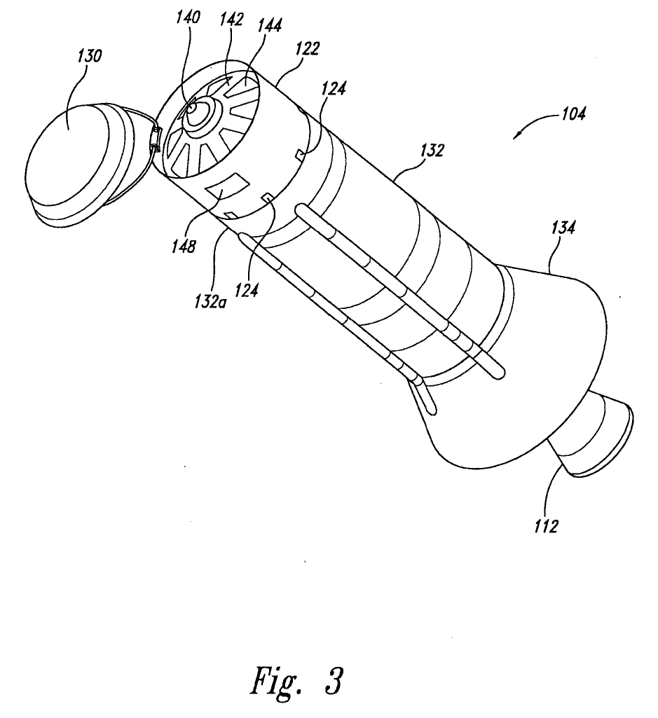

FIGS. 2-3 illustrate the OV 104 and passenger module 122 in greater detail. The OV 104 has a generally elongated cylindrical aerodynamic shape with the module 120 coupled to a first end and the OV engine 112 at the second end. A mid-body portion 132 is cylindrical in shape and contains the OV fuel tanks 114 as well as portions of the OV engine 112, as previously described. A forward-body portion 132a is cylindrical in shape and contains the OV avionics (not shown). An aft-flare or skirt 134 provides a transition from the smaller diameter of the OV 104 to the larger diameter of the LAP 102. The aft-flare 134 may also provide desirable aerodynamic characteristics for the OV 104.

The reusable LAP 102 and OV 104 advantageously permit the attachment of multiple different forms of modules 120, which include payload modules, cargo modules, and passenger modules, for example. Several different forms of passenger modules will be described herein. In addition, the module 120 may take the form of a pressurized cargo module or an unpressurized cargo module. The two forms of cargo modules may be used to deliver supplies to an orbiting vehicle, such as the ISS. A pressurized cargo module is sealed from the environment of space and pressurized. In contrast, an unpressurized cargo module need not be sealed from the environment of space. A payload module may be used to carry cargo, such as satellites, that will be dispensed once the OV 104 has been placed in orbit.

The module 120 is generally cylindrical in shape and may have varying dimensions, such as length, but has common dimensions and mounting characteristics at an orbital vehicle interface 124. These common dimensions and mounting characteristics advantageously permit the easy interchangeability of modules 120 atop the OV 104. Thus, the appropriate module 120 may be selected based on the specific mission parameters. The reusability of the LAP 102, OV 104 and interchangeable modules 120 provide great space launch flexibility and cost efficiency. For example one mission may provide supplies to the ISS. This mission may require the use of an unpressurized cargo module to deliver supplies to the ISS. A subsequent mission may deliver passengers to the ISS. One of the plurality of passenger modules 122, appropriate for the mission parameters, is selected and mounted atop the OV 104. Thus, the operational features of the module 120 may vary from one mission to another. The diameter of the module 120 may also vary except in the region of the orbital vehicle interface 124 to permit the interchangeability described above.

In one embodiment, the module 122 is attached to the OV 104 using bolts at the orbital vehicle interface 124. If an emergency escape is required, such as during the launch mode with a passenger module 122, explosive bolts can be used that are fired to allow separation of the passenger module from the OV 104. In an exemplary embodiment, the interior portion of the mid-body 132 is maintained at a positive air pressure sufficient to provide approximately 6 G separation of the passenger module 122 from the OV 104. The passenger module 122 is provided with parachutes to slow the descent and thereby provide a safe landing for the passengers. The passenger module 122 may also include airbags to supplement those deployed on the OV 104. The airbags also serve to cushion the landing of the passenger module 122. In yet another alternative embodiment, discussed below, the passenger module 122 may be detached from the OV 102 while in orbit and left in orbit or coupled to an object, such as a space station. Details of the detachable passenger module 122 are provided below.

The module 120 is attached to the OV 104 by the orbital vehicle interface 124 as described above. The opposite end of the module 120 comprises a nosecap 130. Once the launch phase of a mission has been completed and the OV 104 is placed in orbit, the nosecap 130 may be moved to an open position, as illustrated in FIG. 3. The nosecap 130 is placed in the closed position for launch and re-entry, but may be opened in the vacuum of space without any detrimental effects on the operation of the OV 104.

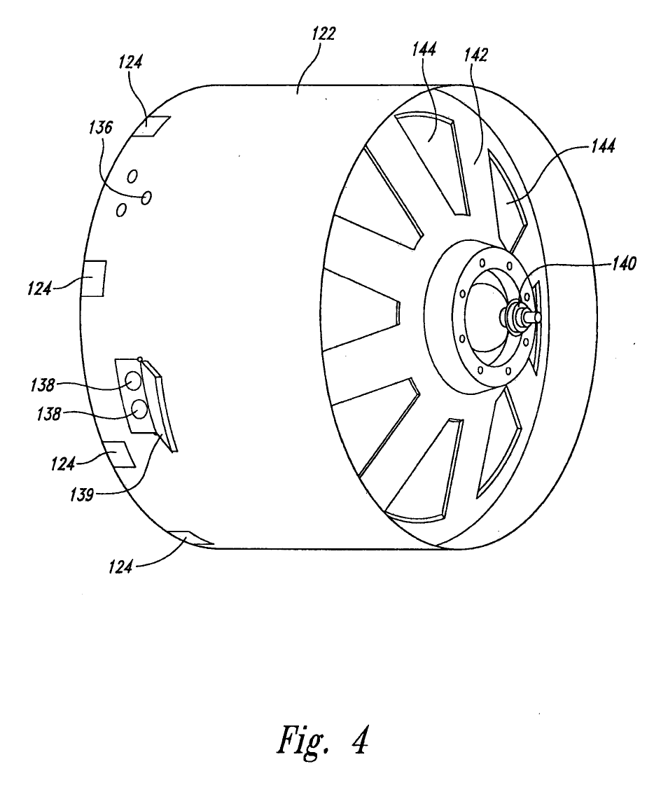

FIG. 4 is a perspective view of the passenger module 122 with the nosecap 130 removed for clarity. When the nosecap 130 is opened, it exposes a docking mechanism 140. Those skilled in the art will appreciate that the docking mechanism 140 may be implemented in a variety of different forms. For example, the U.S. spacecraft often use a standardized commercial docking mechanism known as a common berthing mechanism (CBM). The CBM includes an active device that latches on to an incoming spacecraft and guides it into a locked position. In some implementations a grappling arm is included in addition to the CBM to capture the incoming spacecraft. In contrast, other spacecraft use a docking mechanism. The docking system does not actively latch on to the incoming spacecraft. Other docking and/or berthing mechanisms are also known. The term “docking mechanism,” as used herein, is intended to refer to any docking or berthing mechanism. The present system is not limited by the specific implementation of the docking mechanism. The docking mechanism 140 permits coupling of the passenger module 122 to another orbiting body, such as the ISS. As those skilled in the art will appreciate, the docking mechanism 140 provides a pressurized passageway between the interior of the passenger module 122 and the ISS. The docking mechanism 140 may also provide an attachment mechanism to transfer electrical power, fuel, gases, and liquids, such as LOX. The operation of the docking mechanism 140 is known in the art and need not be described in greater detail herein.

The docking mechanism 140 is mounted in the central area of a dome 142. The dome 142 is an integral structure in the passenger module 122 and provides a solid support for the docking mechanism 140. The dome 142 contains a plurality of windows 144 that permit passenger viewing when the nosecap 130 is in the open configuration (see FIG. 3).

FIG. 4 also illustrates thrusters 136 that are part of an attitude control system (ACS). The thrusters 136 operate in a conventional manner to adjust the attitude of the passenger module 122 and to provide maneuvering power. Also illustrated in FIG. 4 is a star tracker 138 contained within the passenger module 122. Those skilled in the art will appreciate that the star tracker 138 is used to determine the precise position and orientation (i.e., attitude) of the passenger module 122. The star tracker 138 is shielded during lift-off and re-entry by a star tracker door 139. When a position determination measurement is desired, the star tracker door 139 opens and the star tracker 138 locates a plurality of stars. The star pattern formed by the located stars is used to access a database that will provide information regarding the precise location and attitude of the passenger module 122. The star tracker 138 is known in the art and need not be described in greater detail herein.

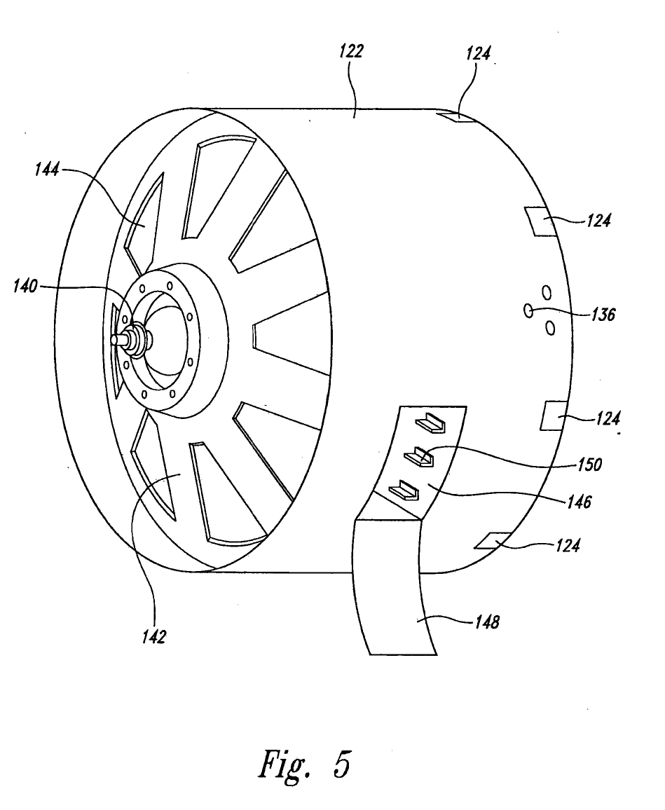

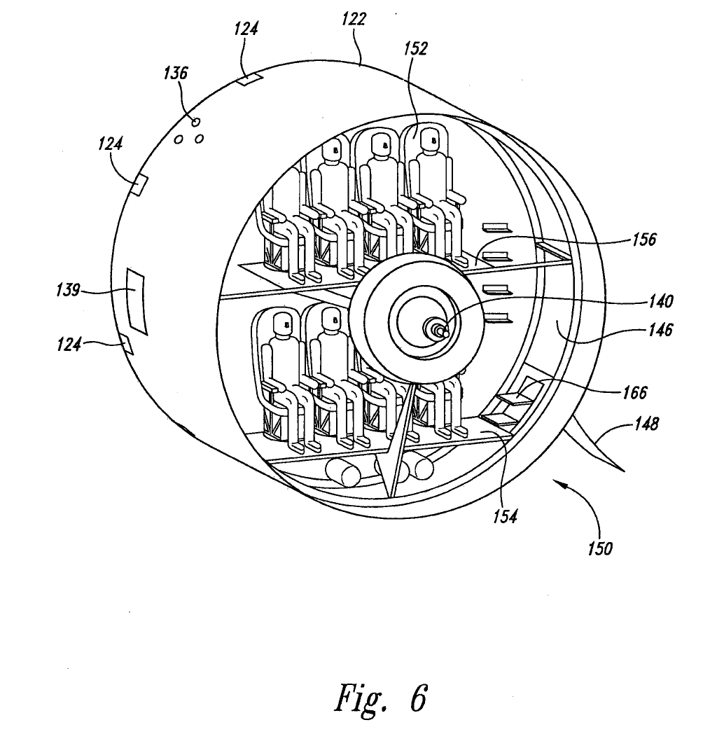

FIG. 5 is a perspective view of the passenger module 122 and illustrates an external hatch 146 and hatch door 148. The hatch door 148 is opened to permit ingress and egress of the passengers prior to launch and after completion of the mission. The parachutes and airbags of the OV 104 orient the passenger compartment 122 in the position illustrated in FIGS. 5-6 upon landing to simplify the passenger offloading process. Additional parachutes and airbags (not shown) may be provided for the passenger module 122 to reduce the landing force to an acceptable level.

FIG. 6 is a front perspective view of the passenger module 122 with the dome 142 removed to provide a better view of an interior portion or passenger compartment 150 of the passenger module. The passenger module 122 illustrated in FIG. 6 is capable of carrying up to eight passengers. A plurality of passenger seats 152 are rotatably mounted to first and second deck plates 154-156, respectively. In an exemplary embodiment, the passenger seats 152 rotate 180 degrees so that the passengers are facing forward (i.e., toward the nosecap 130) during launch and facing rearward during re-entry. This arrangement aligns the highest G-forces with the optimum orientation of the human body.

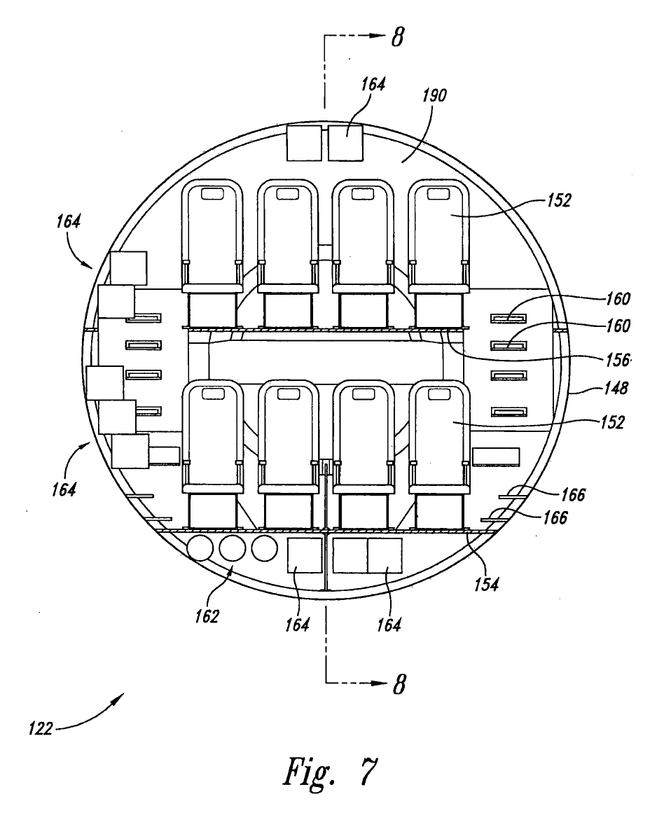

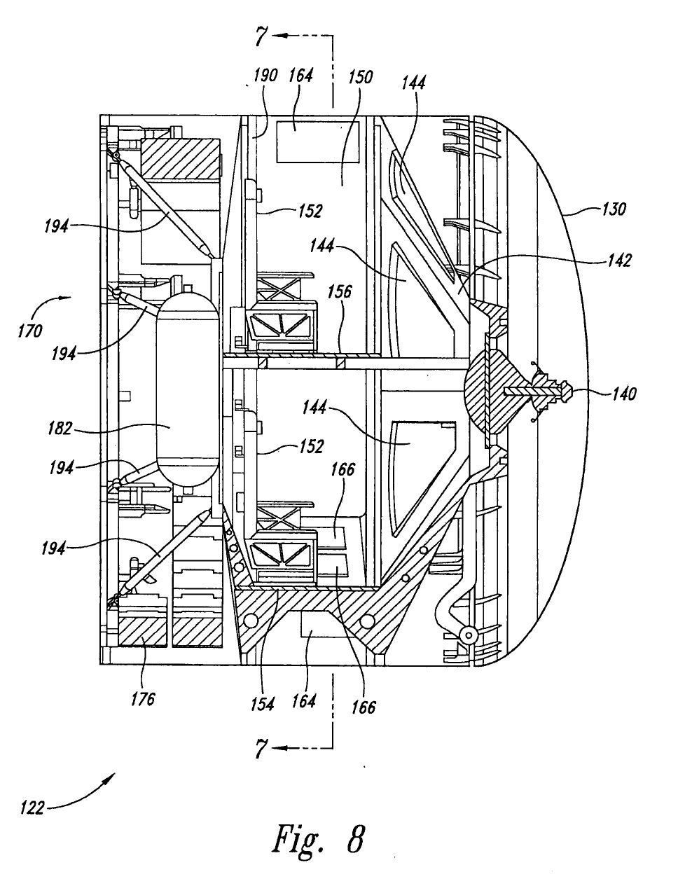

FIG. 7 is a front cross-sectional view of the passenger module 122 taken along the line 7-7 (see FIG. 8). FIG. 7 also illustrates a ladder or steps 160 to allow movement between the passenger seats 152 on the first deck plate 154 and passenger seats on the second deck plate 156. Also illustrated in FIG. 7 are a set of water tanks 162 for water supply and storage.

In an exemplary embodiment, the passenger module 122 also includes a plurality of storage lockers 164 that may conveniently store food, medical supplies, equipment, and personal items for the passengers. The passenger compartment 150 of the passenger module 122 may also include a set of exit stairs 166 to permit passengers to enter and exit through the hatch door 148 (see FIG. 5).

FIG. 8 is a cross-sectional side view of the passenger module 122 taken along the lines 8-8 of FIG. 7. The passenger seats 152, watertanks 162 (see FIG. 7), and storage lockers 164 described above with respect to FIG. 7 are all within the passenger compartment 150 of the passenger module 122. The passenger module 122 also includes an aft equipment area 170. The equipment area 170 contains oxygen tanks, fuel tanks, avionics hardware, and the like. In an exemplary embodiment, the passenger compartment 150 is pressurized while the equipment area 170 is unpressurized. The isolation of equipment within the unpressurized equipment area 170 reduces the ambient noise level within the passenger compartment 150.

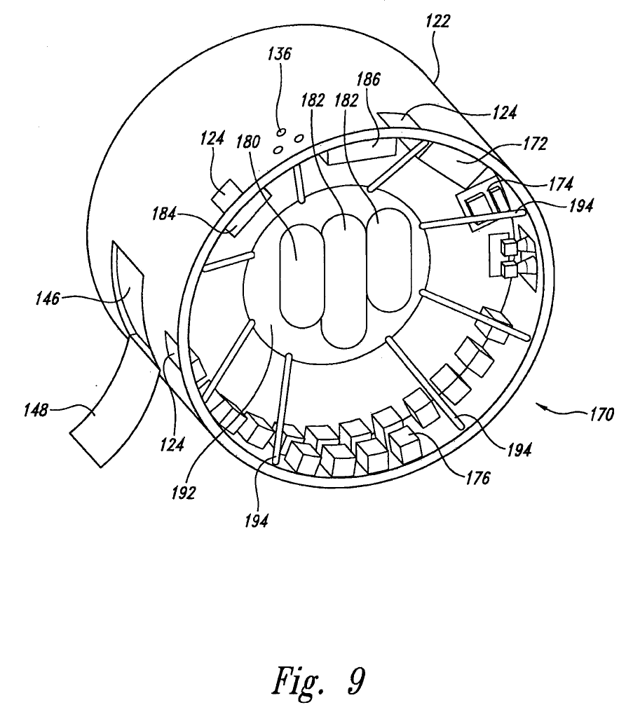

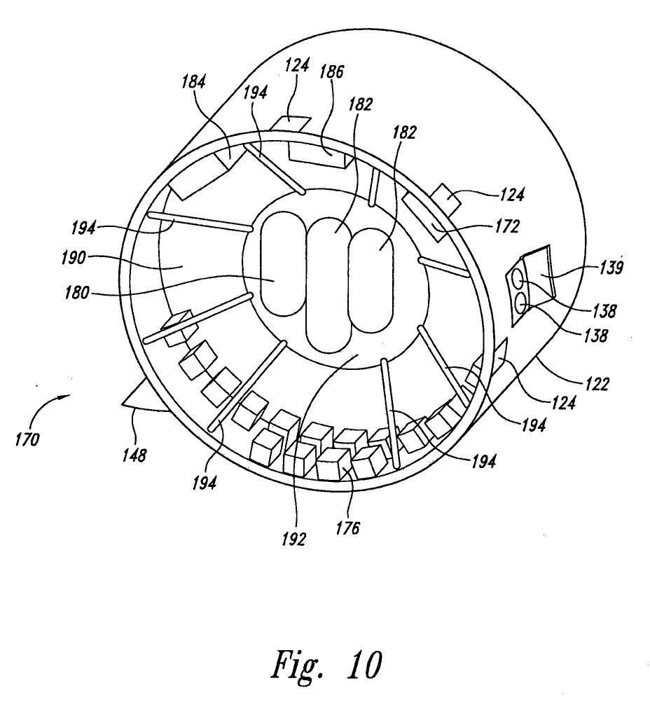

FIGS. 9-10 are rear perspective views of the passenger module 122 illustrating the equipment area 170. Various components, such as the passenger module controller 172 and avionics pallet 174 are mounted in a peripheral region of the equipment area 170. The passenger module controller 172 serves as an interface with the main computer (not shown) on the OV 104 and also functions as a controller for the passenger module 122. For example, the main computer on the OV 104 will initiate a position determination measurement. The main computer sends instructions to the passenger module controller 172 to initiate the position determination. In response, the passenger module controller 172 generates the necessary control signals to open the star tracker door 139 (see FIG. 4) and activate the star trackers 138. In response, the star trackers 138 perform a position determination in the manner described above. The passenger module controller 172 also generates control signals to open the nosecap 130 in orbit and to close the nosecap 130 in preparation for re-entry.

The avionics pallet 174 contains the additional avionics hardware necessary for mission support. The use of an avionics pallet allows quick interchangeability in the event of module failure.

The passenger module 122 is battery powered. To provide a sufficient source of electrical power, a number of batteries 176 are mounted along the periphery of the equipment area 170. The batteries 176 may be configured for operation in multiple electrical circuit branches. The specific architecture of the electrical distribution system is within the scope of knowledge of one having ordinary skill in the art and need not be described in greater detail herein.

The equipment area 170 also contains an oxygen tank 180 and two nitrogen tanks 182. One of the nitrogen tanks 182 is used for the inflation of airbags during the landing process. The remaining nitrogen tank 182 and the oxygen tank 180 are used to provide air to the passenger compartment 150. While earlier U.S. spacecraft used pure oxygen for breathing, the risk of fire in a pure oxygen atmosphere outweighs any benefits of pure oxygen. In an exemplary embodiment, the passenger compartment 150 is supplied with a combination of oxygen and nitrogen in normal atmospheric proportions. An oxygen/nitrogen controller mechanism 186 is also mounted in a peripheral region of the equipment area 170 to regulate the oxygen and nitrogen levels within the passenger compartment 150 of the passenger module 122. The oxygen/nitrogen controller mechanism 186 also controls atmospheric pressure within the passenger compartment 150. In an exemplary embodiment, atmospheric pressure is maintained at a level slightly lower than normal sea level atmospheric pressure.

A lithium hydroxide (LiOH) subsystem 184 operates in a known manner to remove carbon dioxide from the passenger compartment. The LiOH subsystem 184 may include replaceable cartridges that “scrub” the atmosphere within the passenger compartment and remove the carbon dioxide.

FIGS. 9-10 also illustrate support structures for the passenger compartment 150. The passenger compartment itself is defined by the dome 142 which serves as a front wall of the passenger compartment and a rear wall 190, which defines the rear passenger compartment wall. The rear wall 190 also provides structural support for the first and second deck plates 154-156 (see FIG. 8). To improve structural integrity, it is desirable to distribute forces to the outside peripheral wall of the passenger compartment 122. This is accomplished through the use of a central support plate 192 and a plurality of thrust structures 194. The thrust structures 194 are distributed about a peripheral edge of the central support plate 192 and extend to the peripheral outer wall of the passenger module 122. The arrangement of the central support plate 192 and thrust structures 194 distribute the weight of the rear wall 190 and structures supported by the rear wall, such as the first and second deck plates 154-156.

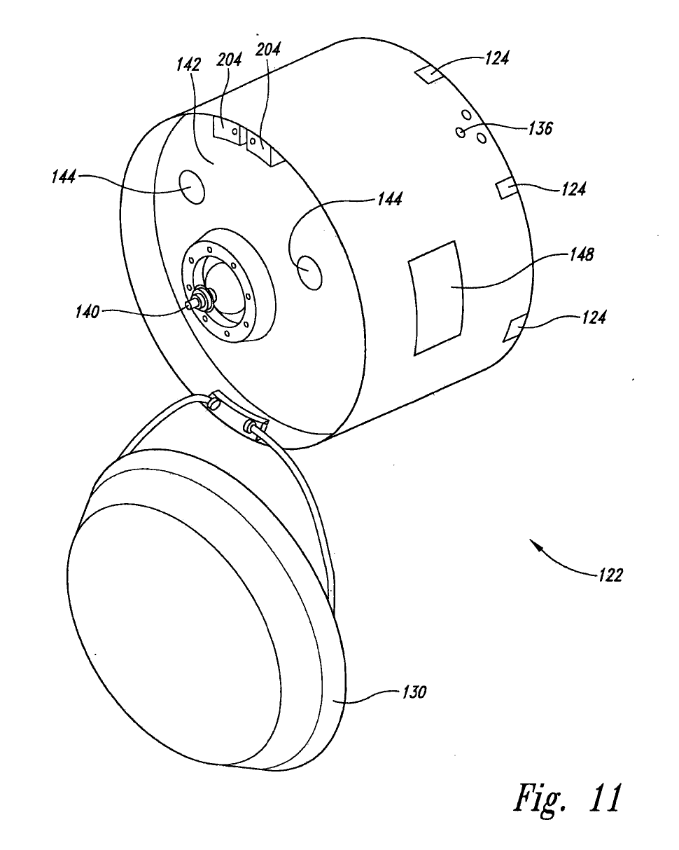

FIGS. 4-8 illustrate an embodiment of the passenger module 122 designed to accommodate eight passengers. Those skilled in the art will appreciate that other configurations are also possible. The external dimensions of the passenger module 122 in the region of the orbital vehicle interface 124 do not vary so as to accommodate interchangeability atop the OV 104 (see FIGS. 1-3). FIG. 11 illustrates an alternative embodiment of the passenger module where the large windows 144 in the dome 142 have been replaced with smaller porthole windows.

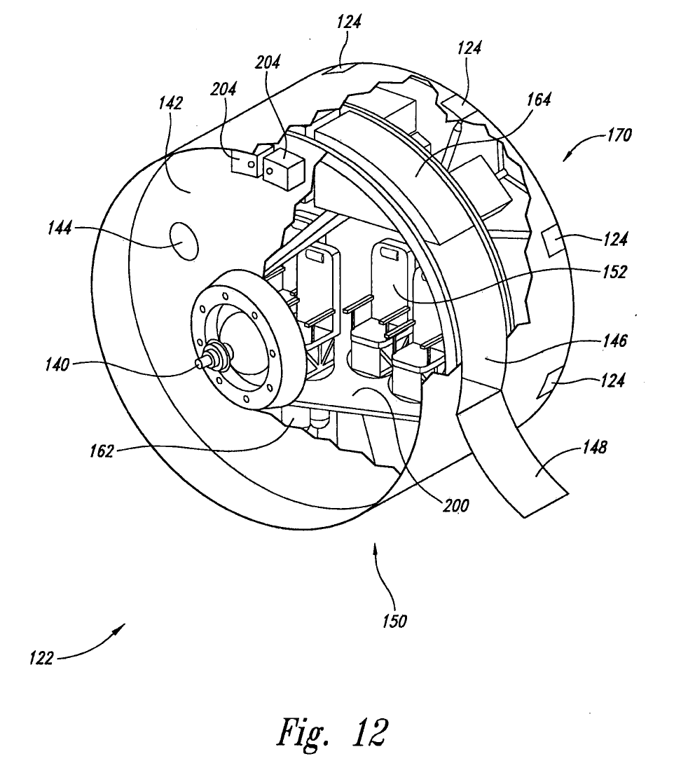

FIG. 12 is a partial cutaway view of the embodiment of the passenger module 122 shown in FIG. 11. For the sake of clarity, the nosecap 130 is not illustrated in FIG. 12. The cutaway provides a partial view of the passenger compartment 150 and the equipment area 170. In the embodiment illustrated in FIG. 12, the multi-decked interior portion has been replaced with a single deck 200 which is positioned even with the bottom of the hatch 146. This arrangement eliminates the need for exit stairs 166 (see FIGS. 6-7). The embodiment of FIG. 12 provides five passenger seats 152 on the single deck 200. This embodiment provides for a significant increase in the size of the storage lockers 164 and may provide additional storage below the single deck 200 to accommodate larger water tanks 162 or the like.

FIG. 12 also illustrates the orbital vehicle interface structures 124 that serve to couple the passenger module 122 to the OV 104 (see FIGS. 1-3). A pair of rendezvous sensors 204 are mounted to the peripheral edge of the passenger module 122. The rendezvous sensors 204 are protected from the heat of launch and re-entry by the nosecap 130 (not shown). While operating in orbit, the nosecap 130 is open thus exposing the rendezvous sensors 204 for proper operation.

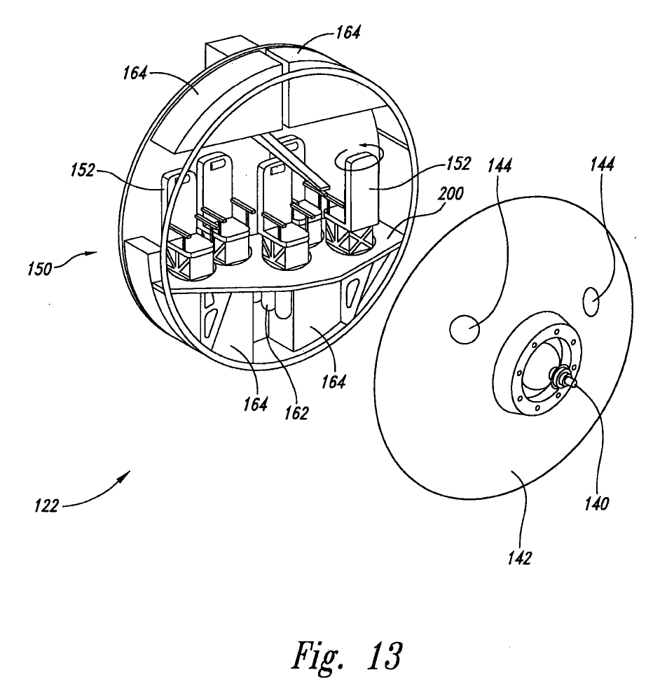

FIG. 13 is a view of the passenger compartment 150 of the passenger module 122 of FIGS. 11-12. For the sake of clarity in viewing, the nosecap 130 (see FIG. 11) is removed and the dome 142 is separated from the passenger compartment 150. The cylindrical exterior walls of the passenger compartment 150 are removed in FIG. 13 to provide better viewing. The increased storage below the single deck is readily apparent in FIG. 13. The size of the storage lockers 164 above the passenger seats 152 are also significantly larger than the eight-passenger embodiment.

FIG. 13 illustrates the rotatable configuration for the passenger seats 152. In an exemplary embodiment, the passenger seats 152 rotate 180 degrees. In FIG. 13, four of the passenger seats are shown in the launch orientation facing the dome 142. The remaining passenger seat 152 has been rotated 180 degrees in a re-entry orientation to face away from the dome 142. It is noted that all passenger seats have rotational capability.

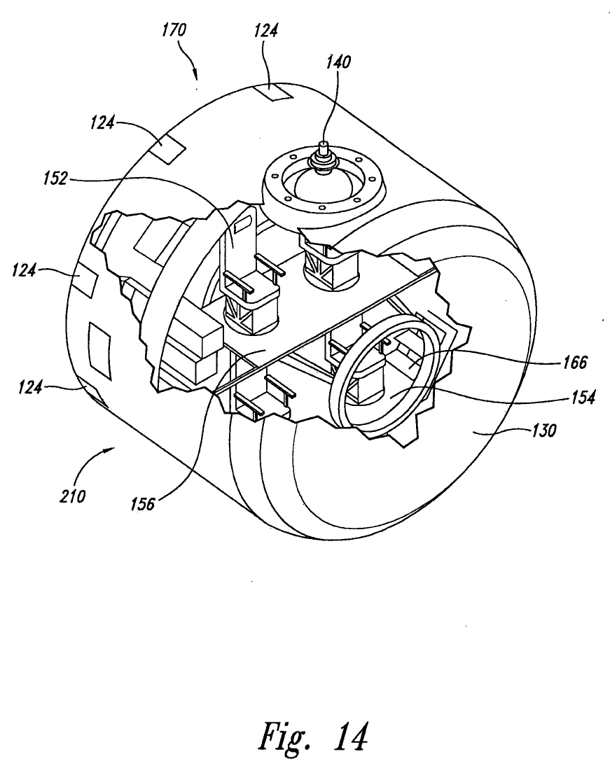

FIG. 14 illustrates another alternative embodiment of the module 120 termed a crew exploration module (CEM) 210. In this variation, the docking mechanism 140 is not positioned beneath the nosecap 130, but is mounted in a sidewall portion of the CEM 210. The cutaway view of FIG. 14 illustrates yet another arrangement for the passenger seats 152. In an exemplary embodiment, the CEM 210 includes four passenger seats 152 arranged on the first and second deck plates 154-156, respectively.

The decrease in the number of passenger seats 152 and the number of passengers allows the CEM 210 to carry additional cargo. This permits longer missions, such as shuttles between low-Earth orbit and, by way of example, a lunar orbit.

As previously discussed, the docking mechanism 140 provides an airlock for passengers to enter and exit the interior portion when the CEM 120 is in a docked position. The docking mechanism 140 also permits the transfer of electrical power, and fluids, such as fuel. In the embodiment illustrated in FIG. 14, the side-mounted CBM may conveniently allow refueling of the OV 104.

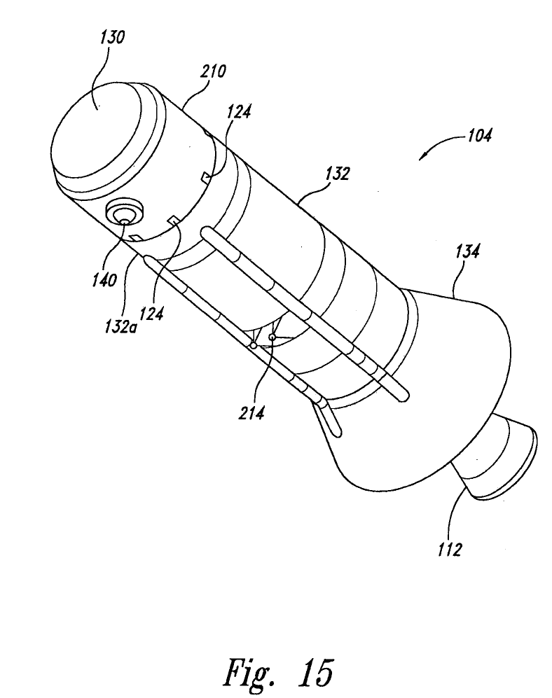

In a typical long duration mission, the LAP 102 provides an initial boost and the OV 104 is placed in earth orbit. With the embodiment illustrated in FIGS. 14-15, the OV 104 may be refueled while in Earth orbit and dock with a lunar lander (not shown) using the docking mechanism 140 as the docking mechanism. The OV engines 112 may be fired to place the OV 104 and attached lunar lander on a lunar trajectory. The passengers transfer from the CEM 210 to the lunar lander for descent to the moon. Thus, the CEM 210 version of the payload module 120 provides additional mission capabilities. It should be noted that external dimensions of the CEM 210 in the region proximate the orbital vehicle interface 124 are identical to the passenger module 122 illustrated in previous figures. This permits interchangeability atop the OV 104.

FIG. 15 illustrates the CEM 210 mounted atop the OV 104. In addition to the modification to place the docking mechanism 140 in the sidewall portion of the CEM 210, the OV may be slightly modified to include an aft lander support 214 in the midbody portion 132 of the OV 104.

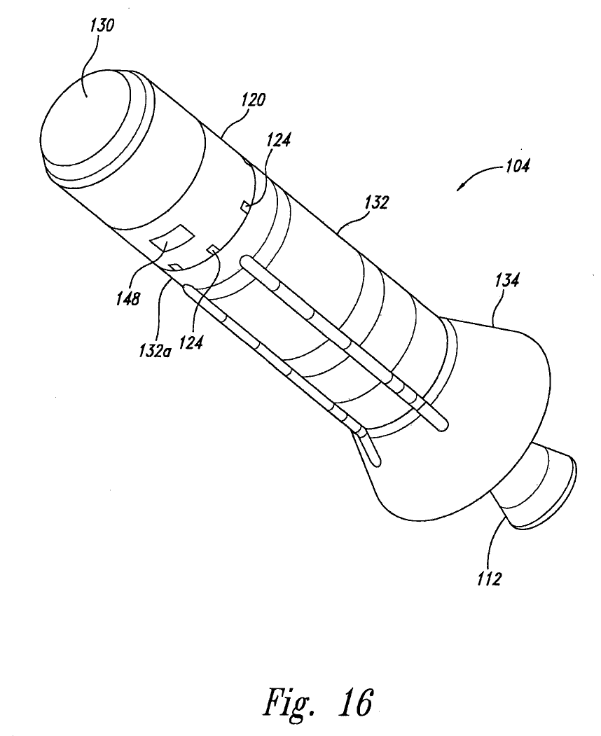

FIGS. 16-18 illustrate yet other alternative embodiments of the module 120. In the embodiment of FIG. 16, the module 120 is cylindrical in shape and has a diameter approximately equal to the diameter of the OV 104. However, the length of the module 120 has been significantly increased. This can accommodate additional passengers and/or cargo. The nosecap 130 operates in the manner described above. The hatch door 148 may be the same size as previously discussed, or may be larger or in a different location to better accommodate loading and unloading procedures.

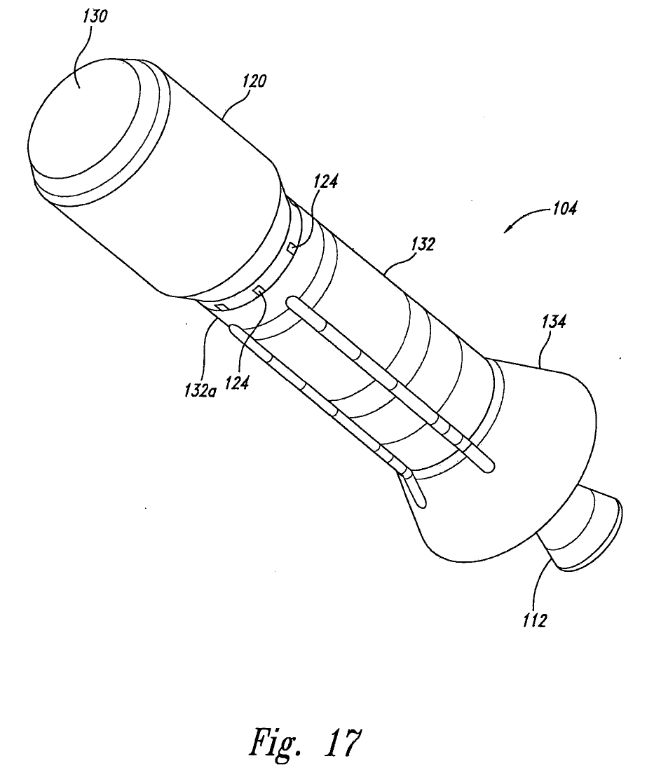

FIG. 17 illustrates an embodiment of the module 120 wherein the length and the diameter of the module are both increased. In an exemplary embodiment, the dimensions of the module 120 in the vicinity of the orbital vehicle interface 124 are sized to couple with the OV 104. Alternatively, an intermediate adapter ring (not shown) can be used to accommodate the transition between the diameter of the OV 104 and the module 120.

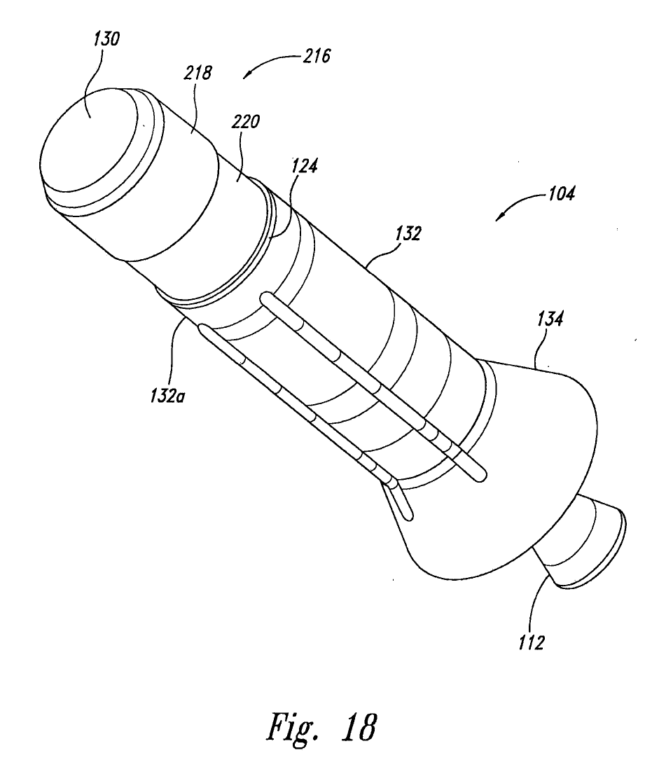

FIG. 18 illustrates yet another alternative embodiment of the module 120. In the embodiment of FIG. 18, the sidewalls of the module 120 form a fairing 216 comprising a forward fairing 218 and an aft fairing 220. The diameter of the aft fairing 220 is less than the diameter of the forward fairing 218 so that the forward fairing can move over the aft fairing in a telescoping manner to a retracted position. The operation of the fairing 216 is illustrated in U.S. Pat. No. 6,059,234, which is assigned to the assignee of the present disclosure. U.S. Pat. No. 6,059,234 is incorporated herein by reference in its entirety.

In a typical operation, the forward fairing 218 is extended to its maximal length to accommodate a large amount of passengers and/or cargo. Once in orbit, and docked to the desired target (e.g., a space station) the passengers and cargo may be unloaded in a manner described above. Following the unloading of the cargo, and possible loading of return cargo, the module 120 is disengaged and the nosecap 130 closed. Under circumstances where only the passenger module 122 is returned to earth, the forward fairing 218 may be adjusted to slide over the aft fairing 220 to the retracted position for the re-entry. Alternatively, the forward fairing 218 may remain in the extended position to accommodate the return of the passenger module 122 and cargo to earth.

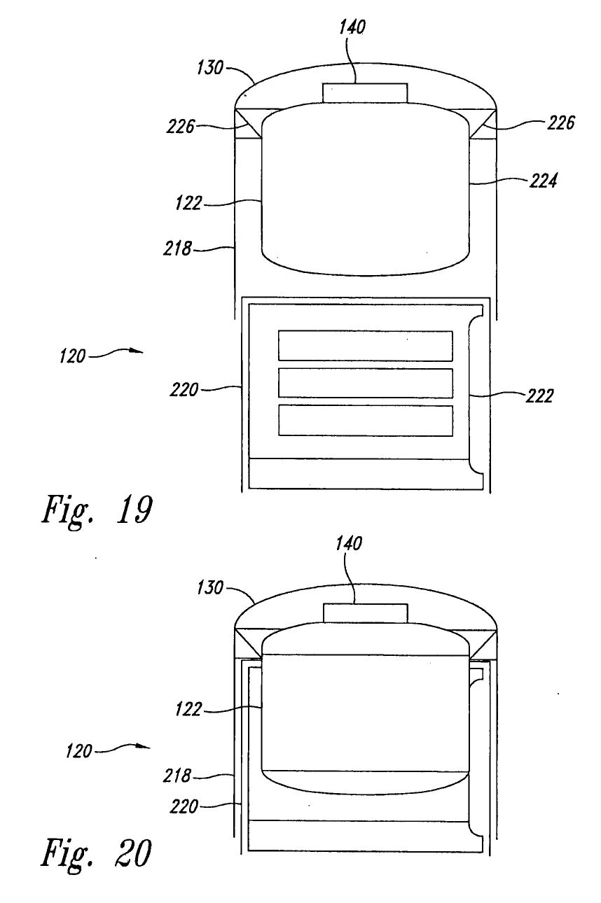

Those skilled in the art will appreciate that the slideable forward fairing 218 may be adjusted to either the retracted or extended position during launch and adjusted to either the retracted or extended position for re-entry as needed. This embodiment is further illustrated in FIGS. 19-20.

FIG. 19 illustrates an embodiment of the module 120 in which the forward fairing 218 is extended to accommodate a combination of the pressurized passenger module 122 and an unpressurized cargo module 222. In orbit, the nosecap 130 is opened to expose the docking mechanism 140. The module 120 can couple to an orbiting craft, such as a space station, using the docking mechanism 140 in the manner described above. As those skilled in the art will appreciate the docking mechanism 140 for the passenger module 122 serves to permit the transfer of passengers through a sealed hatchway formed by the docking mechanism 140. Thus, passengers in the pressurized passenger module 122 are never exposed to the environment of space. Cargo can be removed from the unpressurized cargo module 222 via a hatchway (not shown). Thus, the module 120 of FIGS. 18-20 combines passenger module 122 to permit the transport of passengers to and from the space station with the cargo module 222 to permit the transport of cargo to and from the space station.

FIG. 20 illustrates the use of the module 120 with the forward fairing 218 in the retracted position. In the example illustrated in FIG. 20, the module 120 contains a single pressurized passenger module 122. This embodiment may be used, by way of example, for re-entry to return the passenger module 122 to earth. In one example application of the module 120, FIG. 19 may illustrate an example of a launch configuration where the forward fairing 218 is extended to accommodate the passenger module 122 as well as a large cargo load. The cargo may include unpressurized cargo, pressurized cargo, or a combination. FIG. 19 illustrates a combination of the passenger module 122 and unpressurized cargo. Following delivery of cargo to the orbital destination (e.g., a space station), the forward fairing 218 may be adjusted to its retracted position, as illustrated in FIG. 20, for re-entry. Alternatively, the forward fairing 218 may be left in its extended position, as illustrated in FIG. 19, if the module 120 is carrying return cargo to earth. Various combinations of the module 120 with the forward fairing 218 in the extended position or the retracted position may be readily understood by those skilled in the art.

In the embodiments of the passenger module 122 illustrated in FIGS. 4-13, the sidewalls of the module 120 form the sidewalls of the passenger module 122. In the embodiment illustrated in FIGS. 19-20, sidewalls 224 of the passenger module 122 are independent of the sidewalls of the module 120. The diameter of the passenger module 122 is slightly less than the diameter of the module 120. The passenger module 122 is coupled to the module 120 by a coupling mechanism 226. Other structural supports (not shown) may be used to provide greater structural integrity.

In yet another alternative embodiment, the passenger module 122 may be extracted from the module 120 and left in orbit. The coupling mechanism 226 releasably couples the passenger module 122 to the module 120. The extracted passenger module 122 may be left free floating in orbit or attached to an object such as the space station. At a subsequent time, the extracted passenger module 122 may be reattached to the payload module 120 for a return trip to earth.

Although FIG. 19 illustrates a combination of extractable passenger module 122 and the unpressurized cargo module 222, those skilled in the art can appreciate that the extractable passenger module 122 may be provided in other embodiments, such as those illustrated in FIGS. 4-13, without the combination with the cargo module.

In operation, the specific form of module, whether it is a passenger module (e.g., the passenger module 122 of FIGS. 1-8), a cargo module, a payload module, or the like is selected based on the specific goals of the mission. The common attachment mechanisms of the orbital vehicle interface 124 permit easy interchangeability of the module 120 atop the OV 104. The OV 104 and LAP 102 may be previously assembled at the launch site. When the three components (i.e., the LAP 102, the OV 104, and the module 120) are assembled, the launch phase of the operation may be begin. In an exemplary embodiment, the reusable space launch vehicle 100 is designed for terrestrial launch and recovery. In one embodiment, the LAP 102 provides an initial boost and returns to the launch site a few minutes after the initial launch. Parachutes and airbags (not shown) are used to cushion the landing of the LAP 102. The use of a terrestrial launch site also permits a land recovery of the LAP 102 and OV 104 in the event of an aborted launch. As previously discussed, explosive bolts, which are known in the art, can be used to couple the module 120 to the OV 104. In the event of an aborted launch, the explosive bolts fire and separate the module 120 from the OV 104 as well as the LAP 102 if the mission is aborted in its very early stages.

The nosecap 130 experiences significant heating during the launch and re-entry. To provide the desired level of thermal protection, the nosecap 130 is provided with a thermal protection system (TPS) that allows the necessary degree of heat shielding. The TPS on the nosecap 130 provides thermal protection for components, such as the docking mechanism 140 (see FIG. 3) and the windows 144. This provides a significant design advantage because the windows 144, for example, can be designed to provide the desired degree of protection in the environment of space, but do not have to endure the extreme conditions of heating during the launch and re-entry phases of the mission. Similarly, sensitive components such as the rendezvous sensors 204 (see FIGS. 11-12) are also protected from the extreme heat.

As previously discussed, the nosecap 130 is moved to the open configuration once the OV 104 is outside the atmosphere. This exposes the docking mechanism 140, windows 144, and other components to the environment of space. The OV 104 is in orbit for a variable length of time depending on the mission. In the embodiment illustrated in FIGS. 14-15, the OV 104 may, in fact, leave Earth orbit on a lunar trajectory.

Upon completion of its mission, the OV 104 initiates the re-entry phase of the mission. The nosecap 130 is placed back in the closed configuration and sealed for re-entry. In an exemplary embodiment, the OV 104 is designed to return to the launch site upon completion of its mission in space.

The terrestrial launch and landing may advantageously decrease turnaround time in the preparation of the LAP 102 and OV 104 for subsequent flights. As noted above, these subsequent flights may utilize the same module 120 or may be readily replaced with one of the plurality of interchangeable payload modules, as described above. The reusability and interchangeability features of the reusable space launch vehicle 100 provide a significant cost reduction as compared with conventional technology.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A reusable passenger module system, comprising:
a reusable orbital vehicle (OV) having a first end and a second end;
a propulsion system mounted to the OV interior portion proximate the second end; and
a passenger module configured for use in a plurality of cycles of launch, orbital operation and re-entry, the passenger module being removably coupled to the OV first end; and
a plurality of passenger seats mounted within an interior portion of the passenger module.

2. The system of claim 1, further comprising an automatic guidance system on the OV to thereby eliminate passenger control of the OV.

3. The system of claim 1 wherein the passenger module comprises sidewalls to define an interior portion, the system further comprising a deck plate coupled to the sidewalls with the passenger seats being coupled to the deck plate.

4. The system of claim 1 wherein the passenger module comprises sidewalls to define an interior portion, the system further comprising first and second spaced apart deck plates coupled to the sidewalls with at least a portion of the passenger seats being coupled to the first deck plate and at least a portion of the passenger seats being coupled to the second deck plate.

5. The system of claim 1, further comprising a docking mechanism coupled to the passenger module to permit docking of the passenger module to an orbiting object.

6. The system of claim 5 wherein the orbiting object is a space station having a predetermined space station docking mechanism, the docking mechanism being configured to permit coupling of the passenger module to the space station docking mechanism.

7. The system of claim 5 wherein the passenger seats are within a pressurized environment and the docking mechanism is configured to provide a pressurized passageway between the pressurized environment and the space station.

8. The system of claim 5 wherein a passenger module coupling end is coupled to the OV first end, the system further comprising a moveable nosecap on the passenger module opposite the coupling end and having a closed position and an open position, the docking mechanism being positioned intermediate the interior portion of the passenger module and the nosecap when the nosecap is in the closed position, the docking mechanism being exposed to an environment of space when the nosecap is in the open position.

9. The system of claim 1, further comprising a window in a portion of the passenger module.

10. The system of claim 9 wherein a passenger module coupling end is coupled to the OV first end, the system further comprising a moveable nosecap on the passenger module opposite the coupling end and having a closed position and an open position, the window being positioned intermediate the interior portion of the passenger module and the nosecap when the nosecap is in the closed position, the window being exposed to an environment of space when the nosecap is in the open position.

11. The system of claim 1 wherein a passenger module coupling end is coupled to the OV first end, the system further comprising a moveable nosecap on the passenger module opposite the coupling end, the nosecap having a closed position and an open position.

12. The system of claim 1, further comprising a hatchway in a sidewall portion of the passenger module to permit access to the interior portion of the passenger module.

13. The system of claim 1 wherein the passenger seats are moveably mounted in the interior portion of the passenger module and have a launch orientation and a re-entry orientation.

14. The system of claim 13 wherein the launch orientation positions the passenger seats to face away from the OV first end.

15. The system of claim 13 wherein the re-entry orientation positions the passenger seats to face toward the OV first end.

16. The system of claim 1 wherein the passenger module comprises sidewalls to define an interior portion, the system further comprising a hatch in the sidewall portion to provide access to the interior portion.

17. A reusable passenger module, comprising:
a substantially cylindrical sidewall having first and second spaced apart ends, the sidewall first end configured for removable attachment to an orbital vehicle (OV);
a first passenger compartment wall coupled to the sidewall intermediate the first and second sidewall ends;
a second passenger compartment wall coupled to the sidewall intermediate the first passenger compartment wall and the sidewall second end, the region between the first and second passenger compartment walls defining a passenger compartment; and
a plurality of passenger seats mounted within the passenger compartment.

18. The module of claim 17 wherein the first and second passenger compartment walls are configured to form a pressurized passenger compartment.

19. The module of claim 17, further comprising a deck plate coupled to the sidewall within the passenger compartment, the passenger seats being coupled to the deck plate.

20. The module of claim 17, further comprising first and second spaced apart deck plates coupled to the sidewall within the passenger compartment with at least a portion of the passenger seats being coupled to the first deck plate and at least a portion of the passenger seats being coupled to the second deck plate.

21. The module of claim 17, further comprising a docking mechanism coupled to the second passenger compartment wall to permit docking of the passenger module to an orbiting object.

22. The module of claim 21 wherein the first and second passenger compartment walls are configured to form a pressurized passenger compartment and the docking mechanism is configured to provide a pressurized passageway between the pressurized passenger compartment and the orbiting object.

23. The module of claim 21, further comprising a moveable nosecap on the passenger module at the second sidewall end and having a closed position and an open position, the second passenger compartment wall being positioned intermediate the passenger compartment and the nosecap when the nosecap is in the closed position, the docking mechanism being exposed to an environment of space when the nosecap is in the open position.

24. The module of claim 17, further comprising a docking mechanism coupled to the sidewall intermediate the first and second passenger compartment walls to permit docking of the passenger module to an orbiting object.

25. The module of claim 17, further comprising a window in the second passenger compartment wall.

26. The module of claim 25, further comprising a moveable nosecap on the passenger module at the second sidewall end and having a closed position and an open position, the second passenger compartment wall being positioned intermediate the passenger compartment and the nosecap when the nosecap is in the closed position, the window being exposed to an environment of space when the nosecap is in the open position.

27. The module of claim 17, further comprising a moveable nosecap on the passenger module at the second sidewall end, the nosecap having a closed position and an open position.

28. The module of claim 17 wherein the passenger seats are moveably mounted in the interior portion of the passenger module and have a launch orientation and a re-entry orientation.

29. The module of claim 28 wherein the launch orientation positions the passenger seats to face toward the second passenger compartment wall.

30. The module of claim 28 wherein the re-entry orientation positions the passenger seats to face toward the first passenger compartment wall.

31. The module of claim 17 wherein the first passenger compartment wall is coupled to the sidewall at a location spaced apart from the first end to define an equipment area.

32. The module of claim 31 wherein equipment area is unpressurized.

33. The module of claim 31, further comprising an oxygen storage tank mounted in the equipment area.

34. The module of claim 31, further comprising an avionics package mounted in the equipment area.

35. The module of claim 17, further comprising a coupling portion at the sidewall first end to removably couple the passenger module to the OV.

36. The module of claim 35 wherein the coupling portion comprises explosive bolts to permit separation of the passenger module from the OV.

37. The module of claim 17, further comprising a parachute assembly coupled to the passenger module.

38. The module of claim 17 wherein the first and second passenger compartment walls are removably coupled to the sidewalls, the module further comprising passenger compartment sidewalls fixedly coupled to the first and second passenger compartment walls, the passenger compartment being formed within the first and second passenger compartment walls and the passenger compartment sidewall.

39. The module of claim 38 wherein the passenger compartment is configured for extraction from the passenger module.

40. The module of claim 39, further comprising a docking mechanism coupled to the first passenger compartment wall to permit docking of the passenger compartment with an orbiting object.

41. A reusable module rocket system, comprising:
a reusable orbital vehicle (OV) having a first end and a second end;
a propulsion system mounted to the OV interior portion proximate the second end; and
a plurality of reusable modules, each having a substantially cylindrical sidewall having first and second spaced apart ends, the sidewall first end having substantially identical dimensions and configured for interchangeable attachment to the OV.

42. The system of claim 41, further comprising a moveable nosecap on the passenger module at the second sidewall end, the nosecap having a closed position and an open position.

43. The system of claim 41 wherein the plurality of modules comprise a passenger module, a cargo module and a satellite payload delivery module.

44. The system of claim 43 wherein the cargo module comprises a standard length cargo module and an extended length cargo module.

45. The system of claim 43 wherein the passenger module further comprises:
a first passenger compartment wall coupled to the sidewall intermediate the first and second sidewall ends;
a second passenger compartment wall coupled to the sidewall intermediate the first passenger compartment wall and the sidewall second end, the region between the first and second passenger compartment walls defining a passenger compartment; and
each of the plurality of passenger modules having a different interior configuration and a different number of passenger seats mounted within the passenger compartment.

46. The system of claim 45, further comprising a docking mechanism coupled to the second passenger compartment wall to permit docking of a selected one of the plurality of passenger modules to an orbiting object.

47. The system of claim 46, further comprising a moveable nosecap on the selected one of the plurality of passenger modules at the second sidewall end and having a closed position and an open position, the second passenger compartment wall being positioned intermediate the passenger compartment and the nosecap when the nosecap is in the closed position, the docking mechanism being exposed to an environment of space when the nosecap is in the open position.

48. The system of claim 45, further comprising a docking mechanism coupled to the sidewall intermediate the first and second passenger compartment walls to permit docking of a selected one of the plurality of passenger modules to an orbiting object.

49. The system of claim 45, further comprising a window in the second passenger compartment wall.

50. The system of claim 49, further comprising a moveable nosecap on the passenger module at the second sidewall end and having a closed position and an open position, the second passenger compartment wall being positioned intermediate the passenger compartment and the nosecap when the nosecap is in the closed position, the window being exposed to an environment of space when the nosecap is in the open position.

51. The system of claim 45 wherein the passenger seats are moveably mounted in the interior portion of the passenger module and have a launch orientation and a re-entry orientation.

52. The system of claim 51 wherein the launch orientation positions the passenger seats to face toward the second passenger compartment wall.

53. The system of claim 51 wherein the re-entry orientation positions the passenger seats to face toward the first passenger compartment wall.

54. The system of claim 41 wherein a selected one of the plurality of reusable modules is a passenger module comprising:
first and second passenger compartment walls; and
a passenger sidewall intermediate the first and second passenger compartment walls, the first and second passenger compartment walls and the passenger compartment sidewall configured to form a pressurized passenger compartment interior.

55. The system of claim 54, further comprising a docking mechanism coupled to the second passenger compartment wall to permit docking of the passenger module to an orbiting object.

56. The system of claim 55, further comprising a moveable nosecap coupled to the sidewall on the passenger module and having a closed position and an open position, the second passenger compartment wall being positioned intermediate the passenger compartment interior and the nosecap when the nosecap is in the closed position, the docking mechanism being exposed to an environment of space when the nosecap is in the open position.

57. A method of operating a reusable passenger module system, comprising:
selecting one of a plurality of passenger modules, each of the plurality of passenger modules having a substantially cylindrical sidewall having first and second spaced apart ends, the sidewall first end having substantially identical dimensions and configured for interchangeable attachment to an orbital vehicle (OV);
each of the plurality of passenger modules having a first passenger compartment wall coupled to the sidewall intermediate the first and second sidewall ends;
each of the plurality of passenger modules having a second passenger compartment wall coupled to the sidewall intermediate the first passenger compartment wall and the sidewall second end, the region between the first and second passenger compartment walls defining a passenger compartment;
each of the plurality of passenger modules having a different interior configuration and a different number of passenger seats mounted within the passenger compartment; and
mounting the selected one of the plurality of passenger modules to the OV.

58. The method of claim 57 wherein the passenger seats are moveably mounted in the interior portion of the passenger module, the method further comprising positioning the passenger seats in a launch orientation wherein the passenger seats face toward the second passenger compartment wall.

59. The method of claim 58, further comprising placing the OV and attached passenger module in orbit.

60. The method of claim 57, further comprising docking a selected one of the plurality of passenger modules to an orbiting object using a docking mechanism coupled to the second passenger compartment wall.

61. The method of claim 60, further comprising positioning a moveable nosecap from a closed position to an open position when in an environment of space, the nosecap covering the docking mechanism when in the closed position and exposing the docking mechanism to the environment of space when the nosecap is in the open position.

62. The method of claim 57, further comprising docking a selected one of the plurality of passenger modules to an orbiting object using a docking mechanism coupled to the sidewall intermediate the first and second passenger compartment walls.

63. The method of claim 57, further comprising providing a window useable by passengers in the passenger compartment.

64. The method of claim 63, further comprising positioning a moveable nosecap from a closed position to an open position when in an environment of space, the nosecap covering the window when in the closed position and exposing the window to the environment of space when the nosecap is in the open position.

65. The method of claim 57 wherein the passenger seats are moveably mounted in the interior portion of the passenger module, the method further comprising positioning the passenger seats in a re-entry orientation wherein the passenger seats face toward the first passenger compartment wall.

66. The method of claim 65, further comprising landing the reusable OV and attached passenger module.

67. The method of claim 57, further comprising:
placing the OV and selected one of the plurality of passenger modules in orbit;
landing the OV and selected one of the plurality of passenger modules;
selecting a different one of the plurality of passenger modules;
mounting the selected different one of the plurality of passenger modules to the OV; and
placing the OV and the selected different one of the plurality of passenger modules in orbit.

68. The method of claim 67 wherein the passenger compartment walls are removably coupled to the sidewalls, the method further comprising extracting the passenger compartment from the passenger module.

69. The method of claim 68, further comprising coupling the extracted passenger compartment to an orbiting object.

70. The method of claim 68, further comprising leaving the extracted passenger compartment in orbit.

71. The method of claim 68, further comprising reattaching the extracted passenger compartment to the passenger module prior to reentry.
